(19) United States
(12) Patent Application Publication
(10) Pub. No.: US 2008/0065465 A1
(43) Pub. Date: Mar. 13, 2008

(54) Method for detection of hazard rate increase in time-managed lifetime data

(75) Inventors: Stephen Restivo, Chapel Hill, NC (US); Emmanuel Yashchin, Yorktown Heights, NY (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 11/519,787

(22) Filed: Sep. 13, 2006

(51) Int. Cl. G06Q 10/00; G07G 1/00; G06F 17/30; G06Q 30/00

(52) U.S. Cl. 705/10; 705/1

(57) ABSTRACT

A method for detecting a hazard rate increase in time-managed lifetime data includes specifying acceptable and unacceptable levels of a shape parameter, summarizing rows of a data table by pre-specified criterion and consolidating the data table into a less refined block representation, computing bias-adjusted estimators of the shape parameter for every block in the data table, computing weights wᵢ, i=1, 2, . . . , N corresponding to the estimators ĉᵢ, the weights wᵢ decreasing as the variance of ĉᵢ increases, computing a threshold h to be applied to a set s₁, s₂, . . . , s_{N} defined by s₀=0, sᵢ=max[0, sᵢ₋₁+wᵢ (ĉᵢ−k)], I=1,2, . . . ,N, and applying the threshold to the set s₁, s₂, . . . , s_{N} that was observed and establishing whether sₘₐₓ>h, where sₘₐₓ=max [s₁, s₂, . . . , s_{N}].

### BACKGROUND OF THE INVENTION

1. Field of the Invention

The present invention generally relates to a method for monitoring data, and more particularly to a method and apparatus for simultaneously monitoring collections of time-managed lifetime data streams for detecting a hazard rate increase.

2. Description of the Related Art

It is often desirous to simultaneously monitor collections of time-managed lifetime data streams with the purpose of detecting a hazard rate increase.

For purposes of the present application, a time-managed lifetime data stream refers to a special type of stochastic process indexed by rows of a data table. Every row contains a description of a lifetime-type test (e.g., it specifies the number of items put on test and such quantities as test duration, the fraction of failed items or number of failures observed on various stages of the test, the actual times of failures, etc.). As time progresses, all rows of the table are updated. Additionally, new rows are added to the table and rows deemed obsolete are dropped from the table in accordance with some pre-specified algorithm.

A simple example of such a table is provided herein in Table 1.

TABLE 1

| OBS | DATES | WMONTHS | WREPL | RATES | VOLS. | | 1 | | 2 | | 3 | | 4 | |
|---|---|---|---|---|---|---|---|---|---|---|---|---|---|---|
| 1 | Jan. 2, 2002 | 15 | 0 | 0.000 | 1 | 1 | 0 | 1 | 0 | 1 | 0 | 1 | 0 | 1 |
| 2 | Jan. 3, 2002 | 13 | 0 | 0.000 | 1 | 1 | 0 | 1 | 0 | 1 | 0 | 1 | 0 | 1 |
| 3 | Jan. 4, 2002 | 15 | 0 | 0.000 | 1 | 1 | 0 | 1 | 0 | 1 | 0 | 1 | 0 | 1 |
| 4 | Jan. 18, 2002 | 199 | 2 | 0.001 | 16 | 16 | 0 | 16 | 0 | 16 | 0 | 16 | 0 | 16 |
| 5 | Jan. 25, 2002 | 6 | 1 | 0.167 | 1 | 1 | 0 | 1 | 0 | 1 | 0 | 1 | 1 | 1 |
| 6 | Jan. 28, 2002 | 13 | 0 | 0.000 | 1 | 1 | 0 | 1 | 0 | 1 | 0 | 1 | 0 | 1 |
| 7 | Jan. 29, 2002 | 13 | 0 | 0.000 | 1 | 1 | 0 | 1 | 0 | 1 | 0 | 1 | 0 | 1 |
| 8 | Jan. 30, 2002 | 13 | 0 | 0.000 | 1 | 1 | 0 | 1 | 0 | 1 | 0 | 1 | 0 | 1 |
| 9 | Jan. 31, 2002 | 12 | 0 | 0.000 | 2 | 2 | 0 | 2 | 0 | 2 | 0 | 2 | 0 | 2 |
| 10 | Feb. 1, 2002 | 6 | 0 | 0.000 | 1 | 1 | 0 | 1 | 0 | 1 | 0 | 1 | 0 | 1 |
| 11 | Feb. 4, 2002 | 26 | 0 | 0.000 | 2 | 2 | 0 | 2 | 0 | 2 | 0 | 2 | 0 | 2 |
| 12 | Feb. 6, 2002 | 54 | 4 | 0.074 | 6 | 6 | 0 | 6 | 0 | 6 | 0 | 6 | 0 | 6 |
| 13 | Feb. 7, 2002 | 6 | 0 | 0.000 | 1 | 1 | 0 | 1 | 0 | 1 | 0 | 1 | 0 | 1 |
| 14 | Feb. 11, 2002 | 8 | 1 | 0.125 | 1 | 1 | 0 | 1 | 0 | 1 | 0 | 1 | 0 | 1 |
| 15 | Feb. 12, 2002 | 13 | 0 | 0.000 | 1 | 1 | 0 | 1 | 0 | 1 | 0 | 1 | 0 | 1 |
| 16 | Feb. 15, 2002 | 1 | 1 | 1.000 | 1 | 1 | 1 | 0 | 0 | 0 | 0 | 0 | 0 | 0 |
| 17 | Feb. 18, 2002 | 19 | 0 | 0.000 | 2 | 2 | 0 | 2 | 0 | 2 | 0 | 2 | 0 | 2 |
| 18 | Feb. 19, 2002 | 51 | 0 | 0.000 | 5 | 5 | 0 | 5 | 0 | 5 | 0 | 5 | 0 | 5 |
| 19 | Feb. 21, 2002 | 13 | 0 | 0.000 | 1 | 1 | 0 | 1 | 0 | 1 | 0 | 1 | 0 | 1 |
| 20 | Feb. 22, 2002 | 13 | 0 | 0.000 | 1 | 1 | 0 | 1 | 0 | 1 | 0 | 1 | 0 | 1 |
| 21 | Feb. 23, 2002 | 76 | 0 | 0.000 | 8 | 8 | 0 | 8 | 0 | 8 | 0 | 8 | 0 | 8 |
| 22 | Feb. 25, 2002 | 19 | 0 | 0.000 | 2 | 2 | 0 | 2 | 0 | 2 | 0 | 2 | 0 | 2 |
| 23 | Feb. 26, 2002 | 13 | 0 | 0.000 | 1 | 1 | 0 | 1 | 0 | 1 | 0 | 1 | 0 | 1 |
| 24 | Feb. 27, 2002 | 13 | 0 | 0.000 | 1 | 1 | 0 | 1 | 0 | 1 | 0 | 1 | 0 | 1 |

| OBS | 5 | | 6 | | 7 | | 8 | | 9 | | 10 | | 1 | | 2 | | 3 | |
|---|---|---|---|---|---|---|---|---|---|---|---|---|---|---|---|---|---|---|
| 1 | 0 | 1 | 0 | 1 | 0 | 1 | 0 | 1 | 0 | 1 | 0 | 1 | 0 | 1 | 0 | 1 | 0 | 1 |
| 2 | 0 | 1 | 0 | 1 | 0 | 1 | 0 | 1 | 0 | 1 | 0 | 1 | 0 | 1 | 0 | 1 | 0 | * |
| 3 | 0 | 1 | 0 | 1 | 0 | 1 | 0 | 1 | 0 | 1 | 0 | 1 | 0 | 1 | 0 | 1 | 0 | 1 |
| 4 | 0 | 16 | 0 | 12 | 0 | 12 | 0 | 12 | 0 | 12 | 0 | 12 | 0 | 12 | 1 | 11 | 1 | 10 |
| 5 | 1 | 0 | 1 | 0 | 0 | 0 | 0 | 0 | 0 | 0 | 0 | 0 | 0 | 0 | 0 | 0 | 0 | * |
| 6 | 0 | 1 | 0 | 1 | 0 | 1 | 0 | 1 | 0 | 1 | 0 | 1 | 0 | 1 | 0 | 1 | 0 | * |
| 7 | 0 | 1 | 0 | 1 | 0 | 1 | 0 | 1 | 0 | 1 | 0 | 1 | 0 | 1 | 0 | 1 | 0 | * |
| 8 | 0 | 1 | 0 | 1 | 0 | 1 | 0 | 1 | 0 | 1 | 0 | 1 | 0 | 1 | 0 | 1 | 0 | * |
| 9 | 0 | 2 | 0 | 0 | 0 | 0 | 0 | 0 | 0 | 0 | 0 | 0 | 0 | 0 | 0 | 0 | 0 | * |
| 10 | 0 | 1 | 0 | 0 | 0 | 0 | 0 | 0 | 0 | 0 | 0 | 0 | 0 | 0 | 0 | * | | * |
| 11 | 0 | 2 | 0 | 2 | 0 | 2 | 0 | 2 | 0 | 2 | 0 | 2 | 0 | 2 | 0 | 2 | 0 | * |
| 12 | 0 | 6 | 0 | 4 | 0 | 4 | 0 | 4 | 1 | 3 | 0 | 3 | 3 | 0 | 0 | 0 | 0 | * |
| 13 | 0 | 1 | 0 | 0 | 0 | 0 | 0 | 0 | 0 | 0 | 0 | 0 | 0 | 0 | 0 | 0 | 0 | * |
| 14 | 0 | 1 | 0 | 1 | 0 | 1 | 1 | 0 | 0 | 0 | 0 | 0 | 0 | 0 | 0 | 0 | 0 | * |
| 15 | 0 | 1 | 0 | 1 | 0 | 1 | 0 | 1 | 0 | 1 | 0 | 1 | 0 | 1 | 0 | 1 | 0 | * |
| 16 | 0 | 0 | 0 | 0 | 0 | 0 | 0 | 0 | 0 | 0 | 0 | 0 | 0 | 0 | 0 | 0 | 0 | * |
| 17 | 0 | 2 | 0 | 1 | 0 | 1 | 0 | 1 | 0 | 1 | 0 | 1 | 0 | 1 | 0 | 1 | 0 | * |
| 18 | 0 | 5 | 0 | 3 | 0 | 3 | 0 | 3 | 0 | 3 | 0 | 3 | 0 | 3 | 0 | 3 | 0 | * |
| 19 | 0 | 1 | 0 | 1 | 0 | 1 | 0 | 1 | 0 | 1 | 0 | 1 | 0 | 1 | 0 | 1 | 0 | * |
| 20 | 0 | 1 | 0 | 1 | 0 | 1 | 0 | 1 | 0 | 1 | 0 | 1 | 0 | 1 | 0 | 1 | 0 | * |
| 21 | 0 | 8 | 0 | 4 | 0 | 4 | 0 | 4 | 0 | 4 | 0 | 4 | 0 | 4 | 0 | 4 | 0 | * |
| 22 | 0 | 2 | 0 | 1 | 0 | 1 | 0 | 1 | 0 | 1 | 0 | 1 | 0 | 1 | 0 | 1 | 0 | * |
| 23 | 0 | 1 | 0 | 1 | 0 | 1 | 0 | 1 | 0 | 1 | 0 | 1 | 0 | 1 | 0 | 1 | 0 | * |
| 24 | 0 | 1 | 0 | 1 | 0 | 1 | 0 | 1 | 0 | 1 | 0 | 1 | 0 | 1 | 0 | 1 | 0 | * |

In this table, rows correspond to history of machines shipped on respective dates. For example, row #4 specifies that 16 machines were shipped on Jan. 18, 2002 and as of May 2003, these machines collectively accumulated 204 machine-months of service and suffered 2 replacements. The two failures occurred when the machines were in their 12-th and 13-th months of service, respectively.

The top entry in each cell specifies the number of machines “at risk” in the corresponding time period. One can see that for the first 6 periods (months) there were 16 machines at risk. After the 6-th period, the number of machines at risk dropped to 12 (this could happen, for example, if 4 out of the 16 machines had a 6-month warranty, and so data about failures related to these machines is no longer being compiled). Then, in month 12 of service, one of the machines has suffered a replacement. The data for this machine was no longer collected in the same database, therefore, the number of machines “at risk” in the database has dropped to 11. A replacement in the next month brought the number of machines “at risk” to 10. The final cells in some rows contain stars, which indicate that the data for the corresponding cell is not yet available.

Note that every row of the table can change by the next point in time (e.g., if the table is compiled weekly, this point will be on May 22, 2003). At this time the first several rows of the table may be lost (e.g., if the early machines are no longer in warranty). Additional rows may be appended at the bottom of the table if information about new vintages becomes available.

As another example, consider the problem of warranty data monitoring in a large enterprise, such as a computer manufacturing company. In this application, the company collects information related to field replacement actions for various machines and components. One of the objectives of a monitoring tool is to detect, as early as possible, that a particular component or sub-assembly is causing an unusually high level of replacement actions in the field. It is also desirable to detect, as early as possible, an onset of an increase in the hazard rate of a component. In many practical situations, one can find evidence of the hazard rate increase, while the process of failures still appears nominally under control.

There have previously been no known solutions to the above problems. However, several related methods and systems are somewhat relevant to the problem.

For example, one related method compares the number of predicted failures for every period with the number of observed failures, and computes chi-square statistics for every vintage and period. These values are then aggregated into a single chi-square statistic that is then used as a detection tool.

Other conventional devices have been developed for recording and analyzing reliability data of a unit (e.g., like an aircraft) based on dynamically planned maintenance check data.

Other related methods use rules, hypotheses and collected data in order to detect and isolate a failure in a customer system.

However, none of the related devices allow for the simultaneous monitoring of collections of time-managed lifetime data streams with the purpose of detecting a hazard rate increase as early as possible, while maintaining the overall rate of false alarms at an acceptably low level.

Furthermore, with. conventional methods, it is difficult to design a detection scheme for hazard curves, so that it would have a pre-specified low rate of false alarms, while maintaining a high level of detection capability.

Additionally, with conventional methods, it is difficult to get a meaningful graphical interpretation of trends in the hazard rates, including abrupt change-points, high hazard regimes or onset of trends.

### SUMMARY OF THE INVENTION

In view of the foregoing and other exemplary problems, drawbacks, and disadvantages of the conventional methods and structures, an exemplary feature of the present invention is to provide a method and structure in which collections of time-managed lifetime data streams may be simultaneously monitored with the purpose of detecting a hazard rate increase as early as possible, while maintaining the overall rate of false alarms at an acceptably low level.

In a first aspect of the present invention, a method for detecting a hazard rate increase in time-managed lifetime data includes specifying acceptable and unacceptable levels of a shape parameter, summarizing rows of a data table by pre-specified criterion and consolidating the data table into a less refined block representation, computing bias-adjusted estimators of the shape parameter for every block in the data table, computing weights w₁, i=1, 2, . . . , N corresponding to the estimators ĉᵢ, the weights wᵢ decreasing as the variance of ĉᵢ increases, computing a threshold h to be applied to a set s₁, s₂, . . . , s_{N} defined by s₀=0, sᵢ=max[0, sᵢ₋₁+wᵢ (ĉᵢ−k)], I=1,2, . . . ,N, and applying the threshold to the set s₁, s₂, . . . , s_{N} that was observed and establishing whether sₘₐₓ>h, where sₘₐₓ=max [sᵢ, s₂, . . . , s_{N}].

In accordance with certain aspects of the present invention, a user is able to conduct a massive search of a warranty database and identify elements (e.g., hard drives by vendor A operating on machine type B) that show signs of change in hazard rate (e.g., wear-out) while maintaining a predictably low rate of false alarms. These features are valuable because the number of analyses can easily reach tens of thousands, and with the method of the present invention, a user is able to automatically focus on the most important cases.

The present invention method enables a relatively simple design of a detection scheme, so that it would have a pre-specified low rate of false alarms, while maintaining a hi level of detection capability. Furthermore, the method is computationally efficient, so that very large volumes of data can be processed within a short period of time, enabling a more frequent update of the current condition of a complex process (e.g., warranty monitoring operation).

Additionally, the method of the present invention enables a meaningful (and easily adjustable) graphical interpretation of trends in the hazard rates, including abrupt change-points, high hazard regimes or onset of trends.

Finally, the method of the present invention allows for the quick and statistically valid identification of wearout phenomenon (increasing hazard rate) when monitoring field reliability data. Quick problem identification, while maintaining a low rate of false alarms, is extremely important to managing the exposure to warranty costs and customer satisfaction.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1 illustrates a flow chart of a method for detecting a hazard rate increase in time-managed lifetime data 100 in accordance with an exemplary embodiment of the present invention;

FIG. 2 illustrates a detection/diagnostic display of wear-out conditions for a particular component of a given machine type;

FIG. 3 illustrates an exemplary hardware/information handling system 300 for incorporating the present invention therein; and

FIG. 4 illustrates a signal bearing medium 400 (e.g., storage medium) for storing steps of a program of a method according to exemplary embodiments of the present invention.

### DETAILED DESCRIPTION OF EXEMPLARY EMBODIMENTS OF THE INVENTION

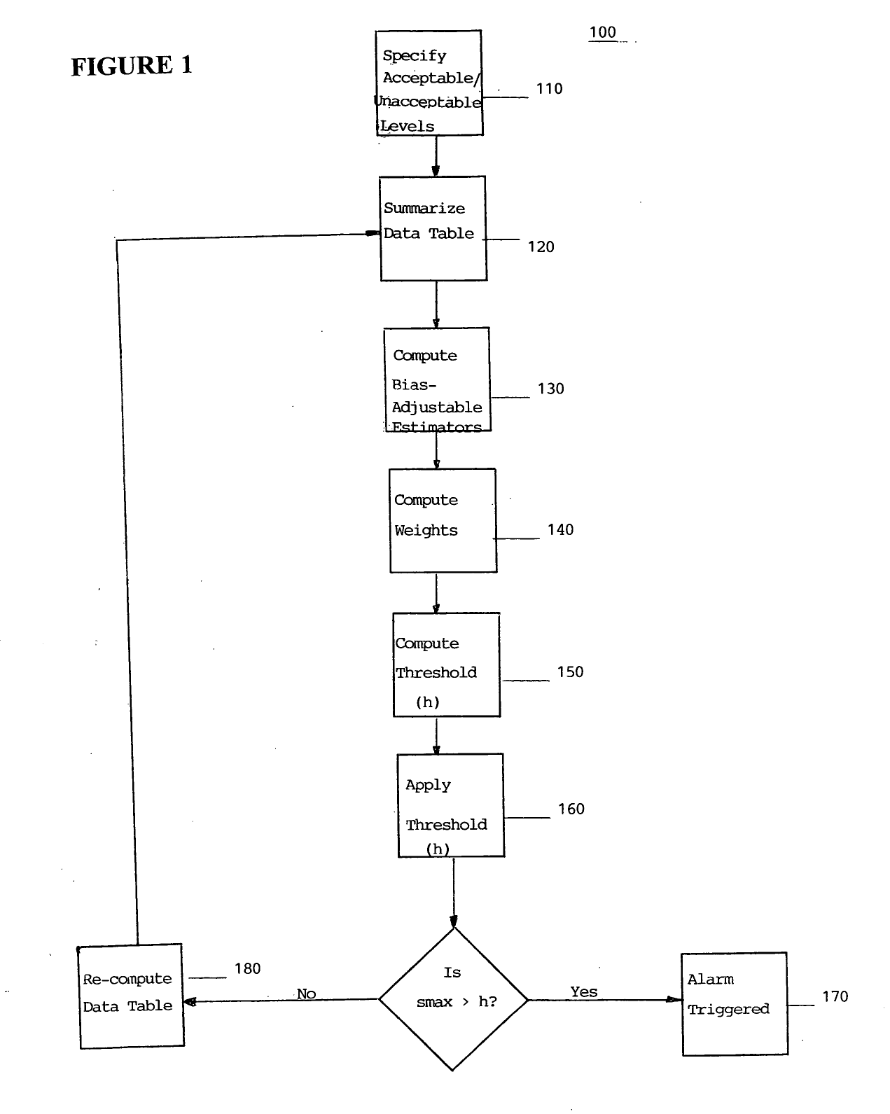

Referring now to the drawings, and more particularly to FIGS. 1-4, there are shown exemplary embodiments of the method and structures according to the present invention.

Certain aspects of the present invention focus on data corresponding to time-managed lifetime data streams. Such streams are typical, for example, when analyzing warranty data, where data for consecutive vintages corresponds to vintage-by-vintage lifetime tests.

For example, a particular item of interest may correspond to a hard drive produced by a vendor A that is used on a machine of type B. For such a machine-type/component combination, the invention calls for specifying a parameter that reflects the shape of the hazard curve and further specifying acceptable and unacceptable levels of this parameter.

In addition, the acceptable rate of false alarms must be specified. This information is used to transform the data to the evidence curve (using a specific algorithm), which, in turn, is compared to a threshold to decide whether the combination should be flagged as one that shows evidence of an unfavorable change in the hazard rate, such as wear-out.

Application of this method to a plurality of components and machine types enables one to filter out (efficiently and with a low rate of false alarms) components that exhibit wear-out conditions with respect to various groups of machine types.

FIG. 1 illustrates a method for detecting a hazard rate increase in time-managed lifetime data 100 in accordance with an exemplary embodiment of the present invention.

The method 100 includes specifying (e.g., step 110) acceptable and unacceptable levels of the shape parameter (c) and interpreting the shape parameter as a shape parameter of a Weibull distribution. An assumption that the underlying distribution is actually distributed as a Weibull distribution is not made, however, decisions are based on an estimation carried out under this assumption. The acceptable and unacceptable values are represented as c₀ and c₁, respectively. It is noted that c₀>c₁ and values of c₀ are typically about 1.

Next, the rows of the data table are summarized (e.g., step 120) by pre-specified criterion (e.g., by vintage month) and the data table is consolidated into a less refined block representation. Note that the basic structural shape of Table 1 is still preserved, however, now the numerators and denominators in each cell correspond to months, not days. The number of blocks resulting from this summarization is denoted as N.

Then, bias-adjusted estimates of the shape parameter c for every block (e.g., for every month worth of shipments) are computed (e.g., step 130). This results in a set {ĉᵢ, i=1, 2, . . . N} of bias-adjusted estimators of the Weibull shape parameter, based on successive blocks.

Next, weights {wᵢ, i=1, 2, . . . , N} corresponding to the estimators {ĉᵢ} obtained above are computed (e.g., step 140). In general, weights wᵢ will decrease as the variance of ĉᵢ increases. They could be chosen, for example, to be equal to the actual estimated variances of the bias-adjusted estimators {ĉᵢ}. Another possibility is to define the weight wᵢ to be equal to the number of failures based on which the estimator ĉᵢ was computed. Note that if there were no failures in the i-th period, then we set ĉᵢ=1 and wᵢ=0, effectively eliminating this period from the decision procedure.

Next, the threshold h to be applied to the set {s₁, s₂, . . . , s_{N}} defined by the equation

s₀=0, sᵢ=max[0, sᵢ₋₁+wᵢ (ĉᵢ−k)], I=1,2, . . . ,N

is computed (e.g., step 150) so as to achieve the following condition:

probability {max [s₁, s₂, . . . , s_{N}]>h, when c=c₀}=P, where the assumed distribution is Weibull and its scale parameters are either assumed to be known, are estimated separately for each block (and then it is assumed that the actual scale parameters are the estimated ones), or are estimated based on segments involving several blocks.

Once the threshold is computed, the computed threshold is applied (e.g., step 160) to the set {s₁, s₂, . . . , s_{N}} that was actually observed and the method establishes whether sₘₐₓ>h, where by definition sₘₐₓ=max [s₁, s₂, . . . , s_{N}]. If sₘₐₓ>h, an alarm is triggered (e.g., 170). In addition, the probability of the set {s₁, s₂, . . . , s_{N}} to exceed the observed value of sₘₐₓ under the assumption that the shape parameter is acceptable (i.e., c=c₀) may be computed and the scale parameters are obtained via one of the methods discussed above. This probability enables one to evaluate the degree of deviation from the acceptable level of the shape parameter, c₀.

If, however, sₘₐₓ is not greater than h, then at the next data updating period, the data table is recomputed (e.g., 180) and the method is repeated starting with summarizing the rows of the data table (e.g., step 120).

### EXAMPLE

### Detection of Wear-Out Conditions

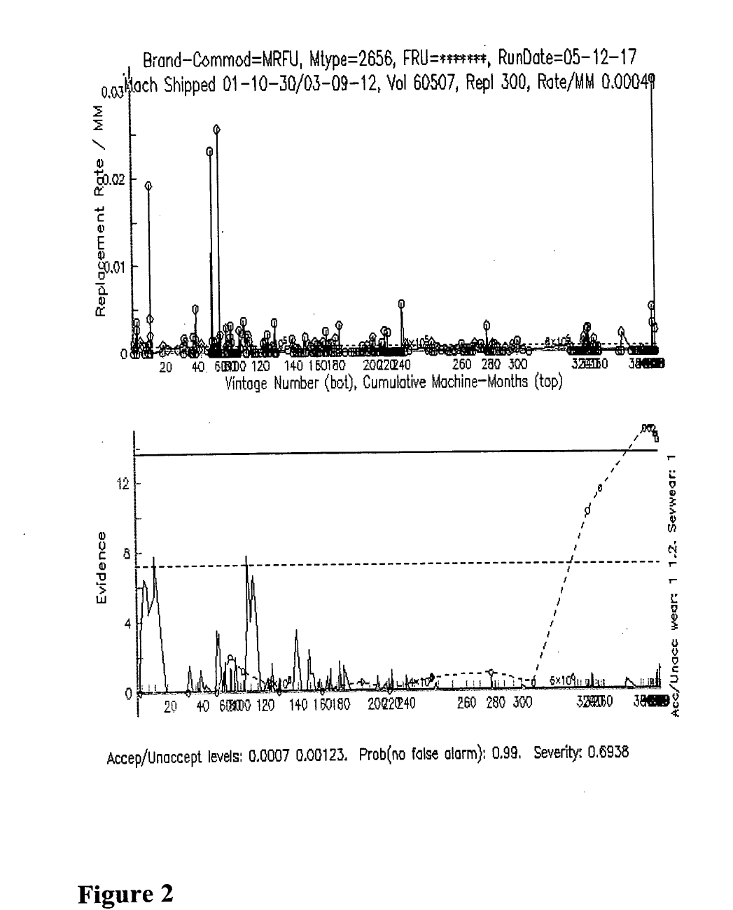

In this example, the detection and diagnosis of wear-out conditions for a particular machine type, with respect to a given component (Field Replaceable Unit=FRU) is demonstrated. The analysis is based on the application of the method 100 described above. The analysis results in alarm conditions and a diagnostic chart depicted in FIG. 2.

On the bottom plot of FIG. 2, the solid line represents evidence related to an increase in the fallout rate, and the solid horizontal line represents the corresponding threshold. The dashed line represents an indicator of wear-out conditions, and the dashed horizontal line represents the corresponding threshold.

FIG. 2 illustrates that the threshold of the wear-out conditions was crossed, indicating onset of wear-out conditions that originated in the month corresponding to vintages 305-320. The data is compiled weekly and the fallout rates are given for daily production (i.e., vintage=day), but the dashed wear-out curve is summarized by month. The circles on the dashed curve indicate month boundaries.

The evidence curve increases for vintages corresponding to three consecutive months. As a result, the severity of wear-out conditions reaches the highest level, 1, as indicated by the vertical text on the right. This text also indicates that the acceptable and unacceptable levels of the Weibull shape parameter are c₀=1 and c₁=1.2, respectively.

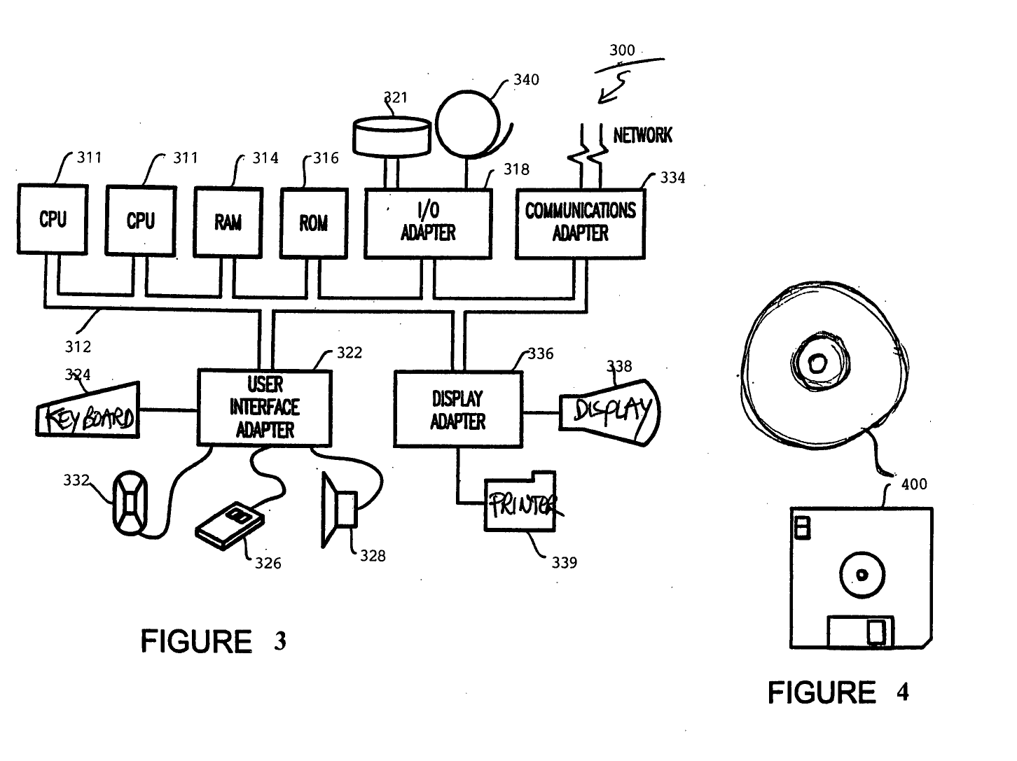

FIG. 3 illustrates a typical hardware configuration of an information handling/computer system in accordance with the invention and which preferably has at least one processor or central processing unit (CPU) 311.

The CPUs 311 are interconnected via a system bus 312 to a random access memory (RAM) 314, read-only memory (ROM) 316, input/output (I/O) adapter 318 (for connecting peripheral devices such as disk units 321 and tape drives 340 to the bus 312), user interface adapter 322 (for connecting a keyboard 324, mouse 326, speaker 328, microphone 332, and/or other user interface device to the bus 312), a communication adapter 334 for connecting an information handling system to a data processing network, the Internet, an Intranet, a personal area network (PAN), etc., and a display adapter 336 for connecting the bus 312 to a display device 338 and/or printer 339 (e.g., a digital printer or the like).

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, comprising signal-bearing media tangibly embodying a program of machine-readable instructions executable by a digital data processor incorporating the CPU 311 and hardware above, to perform the method of the invention.

This signal-bearing media may include, for example, a RAM contained within the CPU 311, as represented by the fast-access storage for example. Alternatively, the instructions may be contained in another signal-bearing media, such as a magnetic data storage diskette 400 (FIG. 4), directly or indirectly accessible by the CPU 311. Whether contained in the diskette 400, the computer/CPU 311, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code.

While the invention has been described in terms of several exemplary embodiments, those skilled in the art will recognize that the invention can be practiced with modification within the spirit and scope of the appended claims.

Further, it is noted that, Applicants' intent is to encompass equivalents of all claim elements, even if amended later during prosecution.

What is claimed is:

1. A method for detecting a hazard rate increase in time-managed lifetime data, comprising:
specifying acceptable and unacceptable levels of a shape parameter;
summarizing rows of a data table by pre-specified criterion and consolidating the data table into a less refined block representation;
computing bias-adjusted estimators of the shape parameter for every block in said data table;
computing weights wᵢ, i=1, 2, . . . , N, corresponding to the estimators ĉᵢ, said weights wᵢ decreasing as the variance of ĉᵢ increases;
computing a threshold h to be applied to a set s₁, s₂, . . . , s_{N} defined by
s₀=0, sᵢ=max[0, sᵢ₋₁+wᵢ (ĉᵢ−k)], I=1,2, . . . , N; and
applying the threshold to the set s₁, s₂, . . . , s_{N} that was observed and establishing whether sₘₐₓ>h, where sₘₐₓ=max [s₁, s₂, . . . ,s_{N}].

2. The method in accordance with claim 1, wherein if sₘₐₓ>h an alarm is triggered.

3. The method in accordance with claim 2, further comprising:
computing a probability of the set s₁, s₂, . . . , s_{N} to exceed an observed value of sₘₐₓ under an assumption that the shape parameter is acceptable.

4. The method in accordance with claim 1, wherein if sₘₐₓ is not greater than the threshold, the data table is recomputed at the next pre-scheduled time of analysis, or upon the arrival of new data and the method is repeated.

5. A signal-bearing medium tangibly embodying a program of machine readable instructions executable by a digital processing apparatus to perform a method for detecting a hazard rate increase in time-managed lifetime data, comprising:
specifying acceptable and unacceptable levels of a shape parameter;
summarizing rows of a data table by pre-specified criterion and consolidating the data table into a less refined block representation;
computing bias-adjusted estimators of the shape parameter for every block in said data table;
computing weights wᵢ, i=1, 2, . . . , N, corresponding to the estimators ĉᵢ, said weights wᵢ decreasing as the variance of ĉᵢ increases;
computing a threshold h to be applied to a set s₁, s₂, . . . , s_{N} defined by
s₀=0, sᵢ=max[0, sᵢ₋₁+wᵢ (ĉᵢ−k)], I=1,2, . . . , N; and
applying the threshold to the set s₁, s₂, . . . , s_{N} that was observed and establishing whether sₘₐₓ>h, where sₘₐₓ=max [s₁, s₂, . . . , s_{N}].
